(19) United States
(12) Patent Application Publication
(10) Pub. No.: US 2006/0218140 A1
(43) Pub. Date: Sep. 28, 2006

(54) Method and apparatus for labeling in steered visual analysis of collections of documents

(75) Inventors: Paul D. Whitney, Richland, WA (US); Susan L. Havre, Richland, WA (US); David R. McGee, Portland, OR (US)

Correspondence Address: WELLS ST. JOHN P.S., 601 WEST FIRST AVENUE, SUITE 1300, SPOKANE, WA, 99201-3828, US

(73) Assignee: Battelle Memorial Institute

(21) Appl. No.: 11/268,282

(22) Filed: Nov. 3, 2005

Related U.S. Application Data
(60) Provisional application No. 60/651,849, filed on Feb. 9, 2005.
(60) Provisional application No. 60/651,841, filed on Feb. 9, 2005.

(51) Int. Cl. G06F 17/30

(52) U.S. Cl. 707/5

(57) ABSTRACT

A method of labeling in steered visual analysis of a collection of documents, the method comprising receiving a query against a database including a collection of documents; representing contents of the query as a matrix; rotating document vectors associated with respective documents to match the matrix to produce a matrix of rotated document vectors; grouping the rotated document vectors into clusters; and displaying a graphic around an area corresponding to a query term.

### CROSS-REFERENCE TO RELATED APPLICATION

This application claims priority from U.S. Provisional Patent Application Ser. No. 60/651,849, filed Feb. 9, 2005, and from U.S. Provisional Patent Application Ser. No. 60/651,841, filed Feb. 9, 2005, both of which are incorporated herein by reference.

### GOVERNMENT RIGHTS STATEMENT

This invention was made with Government support under Contract DE-AC0676RLO1830 awarded by the U.S. Department of Energy. The Government has certain rights in the invention.

### TECHNICAL FIELD

The invention relates to systems and methods for analyzing and/or characterizing the content of electronic documents.

### BACKGROUND OF THE INVENTION

As the global economy has become increasingly driven by the skillful synthesis of information across all disciplines, be they scientific, economic, or otherwise, the sheer volume of information available for use in such a synthesis has rapidly expanded. This has resulted in an ever increasing value for systems or methods which are able to analyze information and separate information relevant to a particular problem or useful in a particular inquiry from information that is not relevant or useful. The vast majority of information available for such synthesis, 95% according to estimates by the National Institute or Science and Technology (NIST), is in the form of written natural language. The traditional method of analyzing and characterizing information in the form of written natural language is to simply read it. However, this approach is increasingly unsatisfactory as the sheer volume of information outpaces the time available for manual review. Thus, several methodologies for automating the analysis and characterization of such information have arisen. Typical for such schemes is the requirement that the information is presented, or converted, to an electronic form or database, thereby allowing the database to be manipulated by a computer system according to a variety of algorithms designed to analyze and/or characterize the information available in the database. For example, vector based systems using first order statistics have been developed which attempt to define relationships between documents based upon simple characteristics of the documents, such as word counts.

The simplest of these methodologies is a search wherein a word or a word form is entered into the computer as a query and the computer compares the query to words contained in the documents in the database to determine if matches exist. If there are matches, the computer then returns a list of those documents within the database which contain a word or word form which matches the query. This simple search methodology may be expanded to multiple words and/or word forms by introducing Boolean operators into the query. For example, the computer may be asked to search for documents which contain both a first query and a second query, or a second query within a predetermined number of words from the first query, or for documents containing a query, which consist of a series of terms, or for documents which contain a particular query but not another query. Whatever the particular parameters, the computer searches the database for documents which fit the required parameters, and those documents are then returned to the user.

Among the drawbacks of such schemes is the possibility that in a large database, even a very specific query may match a number of documents that is too large to be effectively reviewed by the user. Additionally, given any particular query, there exists the possibility that documents which would be relevant to the user may be overlooked because the documents do not contain the specific query term identified by the user; in other words, these systems often ignore word to word relationships, and thus require exacting queries to insure meaningful search results. Because these systems tend to require such exacting queries, these methods suffer from the drawback that the user must have some concept of the contents of the, documents in order to draft a query which will generate the desired results. This presents the users of such systems with a fundamental paradox: In order to become familiar with a database, the user must ask the right questions or enter relevant queries; however, to ask the right questions or enter relevant queries, the user must already be familiar with the database.

To overcome these and other drawbacks, a number of methods have arisen which are intended to compare the contents of documents in an electronic database and thereby determine relationships between the documents. In this manner, documents that address similar subject matter but do not share common key words may be linked, and queries to the database are able to generate resulting relevant documents without requiring exacting specificity in the query parameters. For example, systems using higher order statistics may be characterized by the generation of vectors which can be used to compare documents. By measuring conditional probabilities between and among words contained within the database, different terms may be linked together. Other systems have sought to overcome this limitation by utilizing neural networks or other methods to capture the higher order statistics required to compress the vector space. These systems suffer from considerable computational lag due to the large amount of information that they are processing. Thus, there exists a need for an automated system which will analyze and characterize a database of electronically formatted natural language based documents in a manner wherein the system output correlates documents within the database according to the meaning of the documents and required system resources are minimized.

U.S. Pat. No. 6,484,168 to Pennock et al. (incorporated herein by reference) discloses a System for Information Discovery (SID). The intent of Pennock et al. is to provide a system for analyzing and characterizing a database of electronically formatted natural language based documents wherein the output is information concerning the content and structure of the underlying database in a form that correlates the meaning of the individual documents within the database. A sequence of word filters are used to eliminate terms in the database which do not discriminate document content, resulting in a filtered word set whose members are highly predictive of content. The filtered word set is then further reduced to determine a subset of topic words which are characterized as the set of filtered words which best discriminate the content of the documents which contain them. These two word sets, the filtered word set and the topic set, are then formed into a two dimensional matrix. Matrix entries are then calculated as the conditional probability that a document will contain a word in a row given that it contains the word in the column of the matrix. The number of word correlations which is computed is thus significantly reduced because each word in the filtered set is only related to the topic words, with the topic word set being smaller than the filtered word set. The matrix representation thus captures the context of the filtered words and allows the resultant vectors to be utilized to interpret document contents with a wide variety of querying schemes. Surprisingly, while computational efficiency gains are realized by utilizing the reduced topic word set (as compared with creating a matrix with only the filtered word set forming both the columns and the rows), the ability of the resultant vectors to predict content is comparable or superior to approaches which consider word sets which have not been reduced either in the number of terms considered or by the number of correlations between terms.

The first step of the Pennock et al. system is to compress the vocabulary of the database through a series of filters. Three filters are employed, the frequency filter, the topicality filter and the overlap filter. The frequency filter first measures the absolute number of occurrences of each of the words in the database and eliminates those which fall outside of a predetermined upper and lower frequency range.

The topicality filter then compares the placement of each word within the database with the expected placement assuming the word was randomly distributed throughout the database. By expressing the ratio between a value representing the actual placement of a given word (A) and a value representing the expected placement of the word assuming random placement (E), a cutoff value may be established wherein words whose ratio A/E is above a certain predefined limit are discarded. In this manner, words which do not rise to a certain level of nonrandomness, and thus do not represent topics, are discarded.

The overlap filter then uses second order statistics to compare the remaining words to determine words whose placement in the database are highly correlated with one and another. Measures of joint distribution are calculated for word pairs remaining in the database using standard second order statistical methodologies, and for word pairs which exhibit correlation coefficients above a preset value, one of the words of the word pair is then discarded as its content is assumed to be captured by its remaining word pair member.

At the conclusion of these three filtering steps, the number of words in the database is typically reduced to approximately ten percent of the original number. In addition, the filters have discriminated and removed words which are not highly related to the topicality of the documents which contain them, or words which are redundant to words which reveal the topicality of the documents which contain them. The remaining words, which are thus highly indicative of topicality and non-redundant, are then ranked according to some predetermined criteria designed to weigh them according to their inherent indicia of content. For example, they may be ranked in descending order of their frequency in the database, or according to ascending order according to their rank in the topicality filter.

The filtered words thus ranked are then cut off at either a predetermined limit or a limit generated by some parameter relevant to the database or its characteristics to create a reduced subset of the total population of filtered words. This subset is referred to as a topic set, and may be utilized as both an index and/or as a table of contents. Because the words contained in the topic set have been carefully screened to include those words which are the most representative of the contents of the documents contained within the database, the topic set allows the end user the ability to quickly surmise both the primary contents and the primary characteristics of the database.

This topic set is then utilized as rows and the filtered words are utilized as columns in a matrix wherein each of the elements of the columns and the rows are evaluated according to their conditional probability as word pairs. The resultant matrix evaluates the conditional probability of each member of the topic set being present in a document, or a predetermined segment of the database which can represent a document, given the presence of each member of the filtered word set. The resultant matrix can be manipulated to characterize documents within the database according to their context. For example, by summing the vectors of each word in a document also present in the topic set, a unique vector for each document which measures the relationships between the document and the remainder of the database across all the parameters expressed in the topic set may be generated. By comparing vectors so generated for any set of documents contained within the data set, the documents may be compared for the similarity of the resultant vectors to determine the relationship between the contents of the documents. In this manner, all of the documents contained within the database may be compared to one and another based upon their content as measured across a wide spectrum of indicating words so that documents describing similar topics are correlated by their resultant vectors.

Attention is also directed to U.S. Pat. No. 6,584,220 to Lantrip et al. and to U.S. Pat. No. 6,298,174 to Lantrip et al., both of which are incorporated herein by reference. U.S. Pat. Nos. 6,584,220 and 6,298,174 to Lantrip et al. disclose, among other things, a method of determining and displaying the relative content and context of a number of related documents in a large document set. The relationships of a plurality of documents are presented in a three-dimensional landscape with the relative size and height of a peak in the three-dimensional landscape representing the relative significance of the relationship of a topic, or term, and the individual document in the document set.

Attention is also directed to U.S. patent application Ser. No. 10/602,802, filed Jun. 24, 2003, by inventors James J. Thomas et al., and entitled “Three-Dimensional Display of Document Set”, which is also incorporated herein by reference, and which describes another visualization method and system by the assignee of the present invention.

The system and method described in U.S. Pat. No. 6,772,170 to Pennock et al., incorporated herein by reference, and other patents, is referred to as IN-SPIRE. A predecessor to IN-SPIRE is described in the following article, which is incorporated herein by reference: Wise, J. A.; Thomas, J. J.; Pennock, K.; Lantrip, D; Pottier, M.; Schur, A., and Crow, V., “Visualizing the Non-Visual: Spatial Analysis and Interaction with Information from Text Documents”, IEEE Symposium on Information Visualization '95; Atlanta, Ga. IEEE Computer Society Press; 1995.

The concept of document vectors is also disclosed in the following article, which is incorporated herein by reference: Salton, G.; Yang, C., and Wong, A., “A Vector Space Model for Automatic Indexing”, Communications of the ACM, 1975; 18 (11):613-620.

The concept of clustering, where search results are displayed in clusters around search terms or topics, is disclosed in U.S. Pat. No. 6,574,632 to Fox, which is incorporated herein by references, as well as in other publications mentioned herein.

Analysts who must understand and navigate very large, unstructured document collections may employ exploratory analysis tools, such as those described above, which automatically process the documents and provide an interactive visual Interface, or visualization, to the collection content. Analysts may want to influence or interject their own biases based on the analysts' focus and their experience and knowledge into a visualization. Such “steering” may benefit the harvesting, classification, clustering, and projection of topics, concepts, and documents. Analysts who steer a visualization may want to see visual cues as evidence of the impact of steering.

The design of the exploratory analysis tool, IN-SPIRE, was based, in part, on the notion that the text processing and visualization of a document collection should be data-driven; that is, based on the contents of the documents alone. A visual analysis tool was developed that would process and present the contents of a corpus using statistical methods without bias, independent of evolving and complex natural language processing, and, for example, that would be usable by analysts not expert in the underlying statistical methods. A growing number of users are adept at using the visual analysis tools.

### SUMMARY OF THE INVENTION

Various aspects of the invention relate to labeling in the context of visual analysis of collections of documents.

Some aspects of the invention provide visual cues including labeling that might be employed in conjunction with the implementation of steering. Steering is described, for example, in commonly assigned U.S. Patent Application Docket No. 14224-E (BA4-281) titled “Methods and Apparatus for Steering the Analyses of Collections of Documents”, which names as inventors Paul Whitney, Susan L. Havre, and David McGee, and which is incorporated herein by reference, as well as in commonly assigned U.S. Provisional Application Ser. No. 60/651,841. Some aspects of the invention provide visual cues including labeling that might be employed in conjunction with the implementation of steering as described in these particular patent applications.

Some sophisticated users may want to be able to steer visual analysis; that is, analysts want to influence or interject their own biases based on the analysis' focus and their experience and knowledge into the visualizations. By adding the capability to steer the analysis, the analysts' ability to discover actionable information may be improved. Steering is accomplished, for example, by identifying what is most relevant (especially when those things are not identified or given weight within the corpus itself), based, for example, on an analyst's profile, tasking, etc. Such steering introduces a bias into the document collection largely due to the analyst's domain knowledge. Its influence may benefit the harvesting, classification, clustering, and projection of topics, concepts, and documents as well as labeling and querying.

Currently, analysts apply their biases by harvesting document collections that are especially interesting to them. They submit a (sometimes complex) Boolean text query against a huge document set to identify a document subset for further analysis. This subset contains only documents that are related by their text content to the components of the query. When this focused subset is processed and visualized, the analysts may be surprised to find that some query components are not apparent in the clustering, projection, or labeling of the document subset visualization. That is, in the focused subset, the (apparently missing) query components may be so pervasive that they do not survive the frequency or topicality filtering; such query components are not included in the topic set which is the basis for clustering, projection, and labeling.

Various embodiments provide changes to the text processing and visualization methods and apparatus that align the visualization more closely with the query components as expected by the users. Various approaches are described in the incorporated copending patent application Attorney Docket No. 14224-E (BA4-281) and in U.S. Provisional Application Ser. No. 60/651,841, both by Paul Whitney, Susan L. Havre, and David McGee. Various embodiments of the invention claimed herein specifically address the issues around labeling. Various embodiments may include a change to feature extraction (topic set selection), which is processing that affects subsequent processing, including, for example, clustering and projection and labeling and querying.

Some visual cues, including labeling, evidencing the impact of steering by an analyst, are provided in various document visualization systems and methods, in accordance with some embodiments of the invention. These can be employed, for example, in conjunction with the implementation of a steering algorithm described in copending U.S. Patent Application (Attorney Docket No. 14224-E (BA4-281) and in U.S. Provisional Application Ser. No. 60/651,841.

The copending application Docket No. 14224-E (BA4-281) U.S. and Provisional Application Ser. No. 60/651,841 disclose the following steps:
Step 1. Represent the query contents as an indicator matrix. The query is broken down into “atomic” terms. For example, the query shown in FIG. 1 (of copending application Docket No. 14224-E (BA4-281) U.S. and Provisional Application Ser. No. 60/651,841) contains the following as atomic terms: farm, barn, plough . . . . Then, a matrix is constructed that indicates which document contains which atomic term.
Step 2. Force the atomic query terms to be classified as “topic words” by increasing the topicality value associated with the terms.
Step 3. Rotate the document vectors to match the indicator matrix using canonical correlations. Canonical correlations are known in the art and are described, for example, in: Seber, G. A. F. Multivariate Observations, New York; John Wiley & Sons; 1984. This algorithm is applied to the matrix of document vectors from IN-SPIRE, and an incidence matrix from the query terms. The rotated document vectors then become the vectors that are clustered and projected to create a “summary view.”

### BRIEF DESCRIPTION OF THE DRAWINGS

The patent or application file contains at least one drawing executed in color. Copies of this patent or patent application publication with color drawings will be provided by the Office upon request and payment of the necessary fee.

Preferred embodiments of the invention are described below with reference to the following accompanying drawings.

FIG. 1 is a flow diagram example of how grids are created for a probe tool.

FIG. 2A is a screen shot illustrating an example of use of the probe tool of FIG. 1. An arrow shows the probe point.

FIG. 2B is an alternate (3-dimensional view) screen shot illustrating an example of use of the probe tool of FIG. 1. An arrow shows the probe point.

FIG. 3 is a screen shot of a probe window that opens when the probe tool of FIG. 2A (or 2B) is used, depending on the location on the screen of the probe tool before actuation of the tool.

FIG. 4 is a screen shot of a three-dimensional representation of a database.

FIG. 5 is a screen shot showing an example of canonical feature ellipses overlaid on a two dimensional “galaxy” projection of clusters and documents, and also shows a topic legend inset in accordance with some embodiments.

FIG. 6 is a screen shot of a user interface control that can be used in connection with (shown at the same time as) a probe label as shown in FIG. 3 or clusters as shown in FIG. 5 to allow users to control weight of query terms in cluster or probe labels.

### DETAILED DESCRIPTION OF THE PREFERRED EMBODIMENTS

Various embodiments disclosed herein are embodied in a memory bearing computer readable code loadable in a programmable computer or transmittable over a network such as the Internet (e.g., embodied in a carrier wave). The memory can be any sort of RAM or ROM such as a floppy disk, EPROM, CD-ROM, CD-RW, hard drive, optical drive, etc. The particular programming language selected is not critical, any language which will accomplish the required instructions necessary to practice the method is suitable. Similarly, the particular computer platform selected for running the code which performs the series of instructions is not critical. Any computer platform with sufficient system resources such as memory to run the resultant program is suitable, such as a Sun Microsystems Sparc™ system, a Silicon Graphics Workstation, a personal computer, a networked environment, a mainframe, etc. The database that is to be interrogated includes a series of documents written in some natural language. While the natural language could be English, the methodology will work for any language. The documents are converted into an electronic form to be loaded into the database. This may be accomplished by a variety of methods, including scanning and using optical character recognition on documents that are not already in a text or word processor document format.

As described above and in the incorporated application and patents, at the start of the text processing, a vocabulary is established of all the words in the corpus except those listed as “stop words.” The “topicality” of the vocabulary words is calculated based on their frequency in a document and in the corpus. A vocabulary word that appears many times in one document but not in any other document would be highly topical. A predetermined number, e.g., 200, of the most topical words are considered “topics” and “major terms.” The next most topical words are considered “cross terms.” An association matrix is created that contains co-occurrence information for the topics and cross terms. Each document is represented by a vector having a length corresponding to the predetermined length, e.g. 200. The vector values reflect the relative weight of each topic and its associated cross terms for that document. In the case of a corpus with less than, e.g., 200 topical words, all those words will be considered topics, there will be no cross terms, and the length of the document vectors will match the number of topics (e.g., less than 200).

These document vectors are the basis for most of the remaining processing. Document clustering is based on the Euclidean distance between document vectors. Documents with similar vectors, have a shorter n-space distance and are assigned to the same cluster. The vectors for documents in a cluster are averaged to create a cluster centroid vector. Principle Component Analysis (PCA) is applied to the centroid vectors, in some embodiments, to reduce the, e.g., 200 dimensions to two because 2-D space can be easily displayed on a computer screen. Additional algorithms, such as a gravity projection algorithm, position the cluster centroids and individual documents in the same 2-D plane at a distance from each other to reflect their relative similarity. Similarity is again determined by n-space Euclidean distance.

Labeling

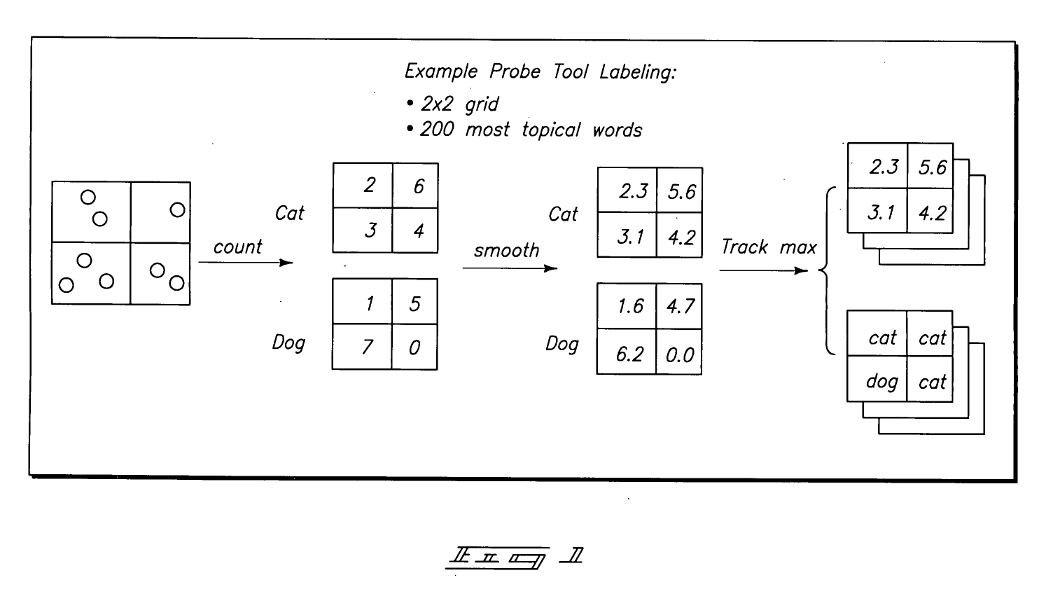

There are two existing approaches to labeling in IN-SPIRE: cluster labeling and probe labeling. For cluster labeling, IN-SPIRE uses the most frequently occurring terms for the documents within the cluster. The order of terms is determined by a count of each term's occurrence in the cluster. Probe labeling is more complex and is used to create labels on demand when a user clicks any place in the visualization with a probe tool. Probe labeling is also used to create labels for peaks in a theme view. For probe labeling, a visualization is divided into a grid (e.g., 100×100 or 10,000 cells). For each of the 200 most topical words, the frequency of that word is summed in all the documents projected into each cell. The frequency sums are then smoothed or normalized across all cells for that word. A predetermined number of top topics are tracked (e.g., the top 10 topics) along with their counts per cell in “grid stacks” (see FIG. 1). The result is an ordered stack of, for example, ten 100×100 grids; each cell contains a topic word and weight calculated from the counts. For example, the top 100×100 grid in the grid stack contains the highest weighted word (and weight) for each cell. The next 100×100 grid contains the second highest word (and weight) for each cell. When a user selects a point with a probe tool, the point is translated to a grid and a label is created showing the highest weighted words.

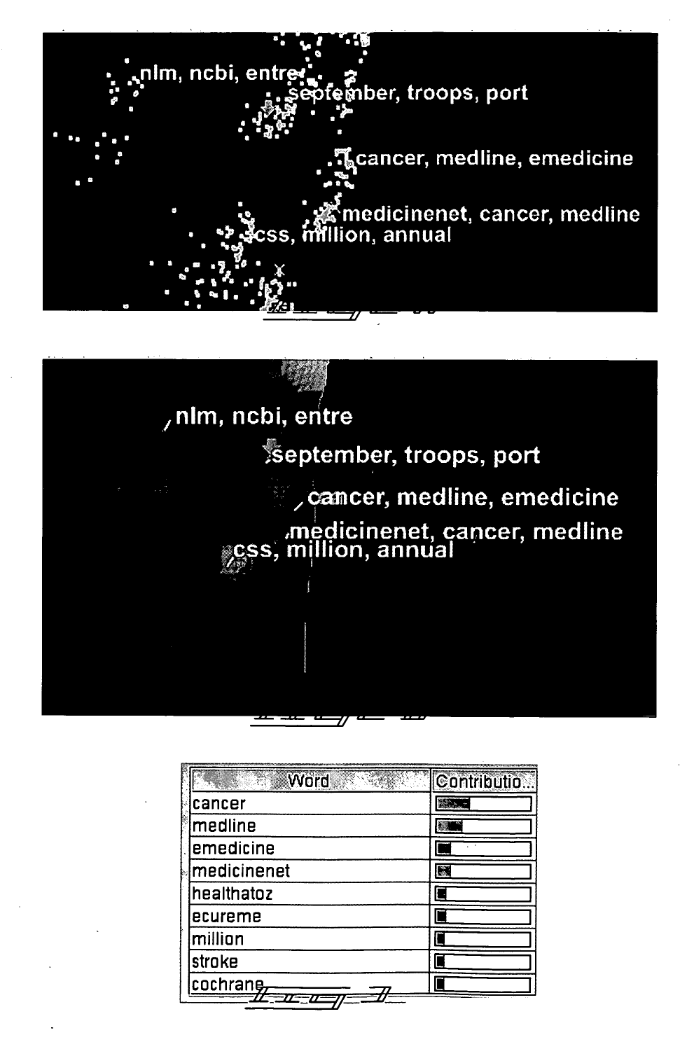

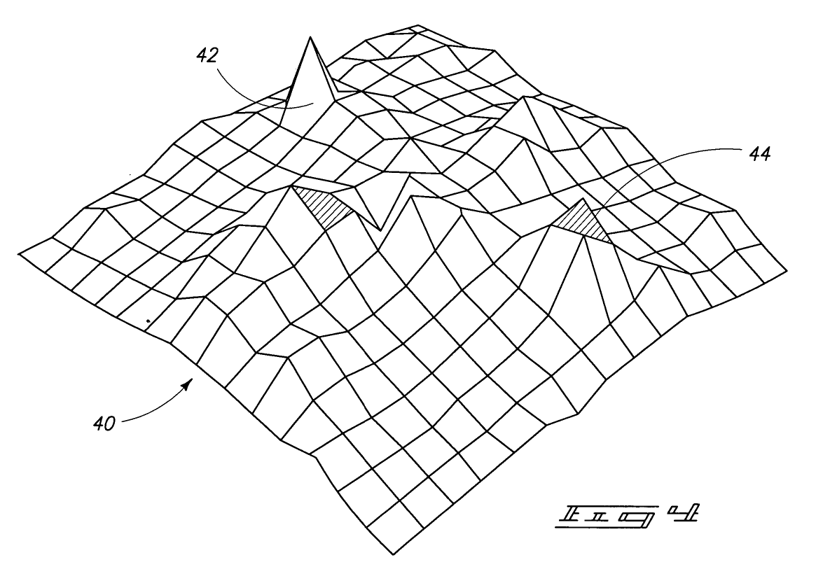

FIGS. 2A and 2B provide examples showing use of the probe tool. To bring up the probe tool, a probe button is selected from a toolbar or menu. A probe cursor 12 (e.g., a downwardly pointing arrow in the illustrated embodiment), comes up on a screen (e.g., a view that comes up in response to a search request) and the probe cursor 12 can be moved around. The probe can be clicked in an area of interest. A probe window then opens (see FIG. 3) and displays a ranked list of the strongest topics at the point where the probe tool was clicked. From the histograms, the user can gain a general understanding of the most important terms in the data set, and where documents strongest in these terms are clustered.

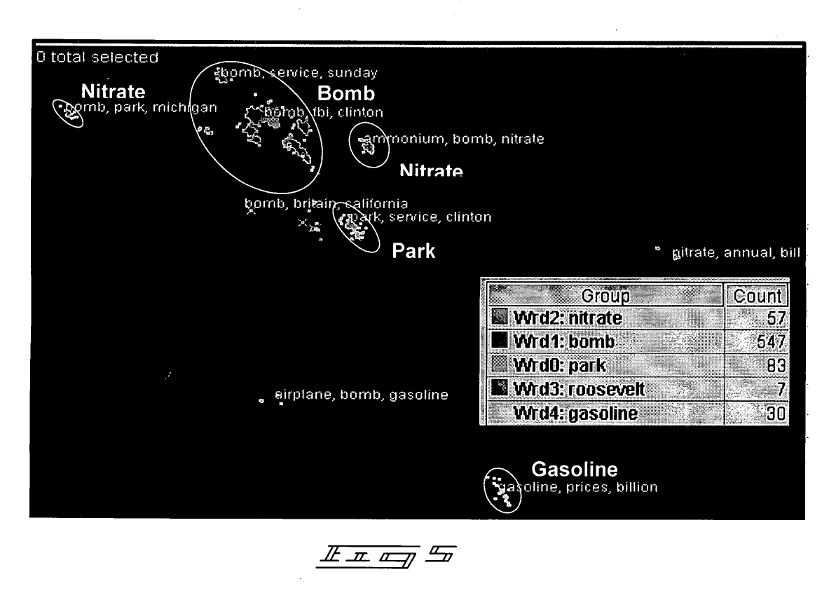

Likewise, in a theme view (see, e.g., FIG. 4 and U.S. Pat. No. 6,584,220 to Lantrip et al. for an example of a theme view), the location of each peak is translated to the same grid and a label is created.

Implementation of Steering Approach

As discussed above, various embodiments provide approaches to handle the problem introduced by applying tools to a focused (query-based harvested) data set. Various embodiments provide: 1) forcing a subset of the words within an analyst-defined category into the current topic structure in IN-SPIRE, 2) revising the topicality and/or association matrix computations, and 3) revising the structures and algorithms within IN-SPIRE to incorporate categories as a first order class of objects. The first approach, which forces the query terms to the top of the topic list, overrides the unbiased feature extraction that is the basis for other processing and the resulting visualizations. The effect of this change alone is to reduce the “discriminable-ness” of the vectors. The principal component analysis will be applied to less discriminating vectors; the result will likely be a less distinct separation of the clusters in the cluster projection.

Testing with canonical correlations demonstrates that this inserts a beneficial steering effect to separate the clusters along the lines of the query terms. So, in addition to forcing the query terms as topics, a canonical correlation algorithm has been applied to align the document vectors with the query terms so that clustering will be heavily influenced by the distribution of query terms across the documents.

These embodiments are described in more detail in the incorporated copending U.S. Patent Application (Attorney Docket No. 14224-E (BA4-281)) and U.S. Provisional Application Ser. No. 60/651,841.

Impact of Implementation On Existing Labeling Approaches

The primary impact of the steering implementation is that for both cluster labeling and probe labeling, the query terms may now appear in the labels because we have forced the query terms as topics. In a sense, we have pre-qualified the query terms to appear in labels. Whether or not the query terms actually appear in the labels will depend on the relative occurrence of the terms within the cluster member documents or grid documents for cluster and probe labeling, respectively.

It should be pointed out that the presence of a term in the harvesting query does not guarantee that the term will be present in documents in the harvested subset. That will depend on the data itself as well as the structure of the query. Consider Query 1 in the example query set below. If none of the documents in the larger data set contain “cat,” then none of the harvested documents can contain “cat.”
Example queries:
Query 1: (horse AND (dog OR cat))
Query 2: (horse OR cow) AND (dog OR cat)
Query 3: (horse AND donkey) OR (dog OR cat)

The structure of the query is also important. Query terms in AND Boolean components at the highest level must necessarily be contained in the query result document set. For example, in the queries above, only the documents retrieved by Query 1 are guaranteed to contain “horse.” Query terms that are OR'd with other components may or may not be contained in the query result set.

The query terms have been more dominant in the theme view labels for the new projections than the standard IN-SPIRE subsets, in various embodiments. Two factors seem likely to contribute to this tendency: 1) The theme view labels are selected from among the topics; once alterations are made, in various embodiments, to ensure that the individual query terms are topics. 2) The new projection tends to concentrate documents with the same individual query terms, thereby increasing the likelihood that these terms are theme view labels.

Improved Labeling

There are two approaches for improving the labeling. One approach leverages a potential product of the new projection implementation to create a complementary labeling method. The second approach is built on changes to the existing labeling implementation.

Approach 1

In the following paragraphs, the phrase “canonical feature” is used to describe either an individual query term, such as “horse” in the sample Query 1 above, or a Boolean query component, such as “dog OR cat” in the same sample query. From the canonical forcing process, a locus or center of gravity is obtained, in some embodiments, for each canonical feature as well as the distances of influence of that feature in two dimensions. The point and distances define an ellipse that locates and bounds the area of influence for each canonical feature. Because the 2-D axes for the projection of the cluster centroids and the canonical features are the same, there is exact alignment or co-registration. In this way, in some embodiments, the area associated with each canonical feature is depicted and labeled relative to the cluster projection. The canonical feature labels are the query terms or components used in the canonical processing.

For example, consider the following harvesting query: (horse AND (dog OR cat)). If the canonical schema is based on terms alone, there would be three areas, one each for horse, dog, and cat. On the other hand, if the canonical schema is based on the query terms and components, there could be five areas, one each for horse, dog, cat, (dog OR cat), and (horse AND (dog OR cat)). Some of the areas will overlap, for example, dog and (dog OR cat).

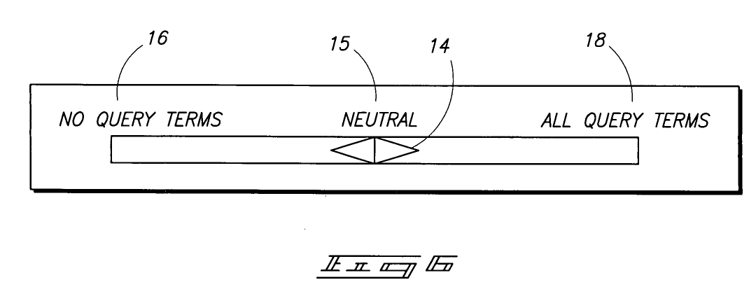

In one embodiment, the display of canonical features overlaid on the 2-D galaxy of clusters and documents shows the center and/or ellipse with a dot and/or a closed line, respectively. See FIG. 5 for a graphic sample. In alternative embodiments, the area is depicted by a cloud or other graphic primitive under the user's control. In some embodiments, the labels are hidden or shown on user demand. In some embodiments, the areas are selectable from the graphic display or from a list of query terms.

Approach 2

An alternate embodiment extends the current implementation to allow the user to force the query terms to bubble up or sink down the ordered topic list created for a label. Given the current implementations of labeling as described above, the query terms may or may not appear in the cluster or probe labels depending on the initial data set, the query structure, and their relative occurrence in the target documents. In some embodiments, the current implementation is altered to allow the user to steer the amount of query term influence in the labels.

More particularly, in some embodiments, a user interface control such as a slider 14 (see FIG. 6) is provided using which a user can weight the influence of query terms in the cluster or probe labels (e.g., by clicking and dragging). The default slider position, in the illustrated embodiment, is neutral where the labels are constructed without weights. The user may force the query terms into the labels by applying a positive weight or force the query terms out of the labels by applying a negative weight.

In some embodiments, in the neutral position 15, the labels show or hide query terms depending strictly on their relative occurrence in the subject documents. In the no-query-terms position 16, the labels do not show query terms; in the all-query-terms position 18, labels show only applicable query terms.

To implement this approach, labels are calculated on demand. Query terms are weighted according to the current setting of the slider. For cluster labels, the query terms' occurrence value is weighted before the terms are sorted for construction of the ordered gist list. The implementation for the probe tool is more complex because the current grid stack assumes a static ordering per grid cell. The following illustrates an implementation for the probe labeling in accordance with some embodiments.

Using the current algorithms for calculating the grid stack, calculate two grid stacks, one of the top n (currently 10) non-query term topics and the other of all the query terms. The query term grid stack has the rank order of all query terms per cell. Upon demand for a label, the current slider setting is used to weigh the query terms' occurrence value before the non-query and query terms are merged and ordered to calculate the label. The on-the-fly labels are calculated on demand, for example, if the slider changes for clusters, probe points, or theme peaks. In alternative embodiments, one ordered list is kept and the order for cluster and probe cell labels is recalculated when the query term weight changes.

The advantage of this capability is that the user can adjust the labels to show or hide the query terms not only to overcome variations in the query structure from one data set to another, but also to explore query term impact in the labels.

In some embodiments, the same weight will be applied to all the query terms. In practice, alternative embodiments, the user is allowed to apply weights to individual query terms (e.g., multiple sliders or other graphical or non-graphical user interface input mechanisms are provided). The weighting of query terms in the labels is important contextual information and should be apparent to the user. The user may want the capability to mark or save alternate weightings or to establish a weighting preference for a data set or in general.

A methodology is provided that finesses the issue of evaluation criteria by using the opinions of analysts. The gist of the evaluation methodology is to measure human assessment of algorithmically generated labeling.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of labeling in steered visual analysis of a collection of documents, the method comprising:
receiving a query against a database including a collection of documents;
representing contents of the query as a matrix;
rotating document vectors associated with respective documents to match the matrix to produce a matrix of rotated document vectors;
grouping the rotated document vectors into clusters; and
displaying a graphic around an area corresponding to a query term.

2. A method in accordance with claim 1 wherein the graphic comprises an ellipse.

3. A method in accordance with claim 1 wherein the graphic comprises a user selectable graphic selected from a plurality of available graphics.

4. A method in accordance with claim 1 and further comprising labeling the clusters.

5. A method in accordance with claim 2 and further comprising providing a label proximate the ellipse.

6. A method in accordance with claim 4 wherein the labeling comprises applying a label corresponding to a term included in the query.

7. A computer readable medium bearing computer program code which, when loaded in a computer, causes the computer to:
receive a query against a database including a collection of documents;
represent contents of the query as a matrix;
rotate document vectors associated with respective documents to match the matrix to produce a matrix of rotated document vectors;
group the rotated document vectors into clusters; and
display a graphic around an area corresponding to a query term.

8. A computer readable medium in accordance with claim 7 wherein the graphic comprises an ellipse.

9. A computer readable medium in accordance with claim 7 wherein the graphic comprises a user selectable graphic selected from a plurality of available graphics.

10. A computer readable medium in accordance with claim 7 and further comprising labeling the clusters.

11. A computer readable medium in accordance with claim 8 and further comprising providing a label proximate the ellipse.

12. A computer readable medium in accordance with claim 10 wherein the labeling comprises applying a label corresponding to a term included in the query.

13. A method comprising:
semantically filtering a set of documents in a database to extract a set of semantic concepts, to improve an efficiency of a predictive relationship to its content, based on at least one of word frequency, overlap and topicality;
defining a topic set, the topic set being characterized as the set of semantic concepts which best discriminate the content of the documents containing them, the topic set being defined based on at least one of word frequency, overlap and topicality;
forming a matrix with the semantic concepts contained within the topic set defining one dimension of the matrix and the semantic concepts contained within the filtered set of documents comprising another dimension of the matrix;
calculating matrix entries as the conditional probability that a document in the database will contain each semantic concept in the topic set given that it contains each semantic concept in the filtered set of documents;
providing the matrix entries as document vectors to interpret the document contents of the database;
inputting query terms;
augmenting the topic set by the query terms;
making an incidence matrix of query terms for the documents;
rotating the document vectors to match the incidence matrix;
clustering and projecting the rotated document vectors; and
displaying a graphic around a cluster and labeling the graphic with a query term related to the cluster.

14. A method in accordance with claim 13 wherein the graphic comprises an ellipse.

15. A method in accordance with claim 14 wherein the graphic comprises a user selectable graphic selected from a plurality of available graphics.

16. A method in accordance with claim 13 wherein the labeling comprises displaying the query term proximate the ellipse.

17. A computer readable medium bearing computer program code which, when loaded in a computer, causes the computer to:
semantically filter a set of documents in a database to extract a set of semantic concepts, to improve an efficiency of a predictive relationship to its content, based on at least one of word frequency, overlap and topicality;
define a topic set, the topic set being characterized as the set of semantic concepts which best discriminate the content of the documents containing them, the topic set being defined based on at least one of word frequency, overlap and topicality;
form a matrix with the semantic concepts contained within the topic set defining one dimension of the matrix and the semantic concepts contained within the filtered set of documents comprising another dimension of the matrix;
calculate matrix entries as the conditional probability that a document in the database will contain each semantic concept in the topic set given that it contains each semantic concept in the filtered set of documents;
provide the matrix entries as document vectors to interpret the document contents of the database;
input query terms;
augment the topic set by the query terms;
make an incidence matrix of query terms for the documents;
rotate the document vectors to match the incidence matrix;
cluster and project the rotated document vectors; and
display a graphic around a cluster and labeling the graphic with a query term related to the cluster.

18. A computer readable medium with claim 17 wherein the graphic comprises an ellipse.

19. A computer readable medium in accordance with claim 18 wherein the graphic comprises a user selectable graphic selected from a plurality of available graphics.

20. A computer readable medium in accordance with claim 17 wherein the labeling comprises displaying the query term proximate the ellipse.

21. A method comprising:
semantically filtering a set of documents in a database to extract a set of semantic concepts, to improve an efficiency of a predictive relationship to its content, based on at least one of word frequency, overlap and topicality;
defining a topic set, the topic set being characterized as the set of semantic concepts which best discriminate the content of the documents containing them, the topic set being defined based on at least one of word frequency, overlap and topicality;
forming a matrix with the semantic concepts contained within the topic set defining one dimension of the matrix and the semantic concepts contained within the filtered set of documents comprising another dimension of the matrix;
calculating matrix entries as the conditional probability that a document in the database will contain each semantic concept in the topic set given that it contains each semantic concept in the filtered set of documents;
providing the matrix entries as document vectors to interpret the document contents of the database;
inputting query terms;
augmenting the topic set by the query terms;
making an incidence matrix of query terms for the documents;
rotating the document vectors to match the incidence matrix;
clustering and projecting the rotated document vectors;
displaying labels for clusters; and
providing a user interface using which a user can adjust the influence of query terms in the labels.

22. A method in accordance with claim 21 wherein the user interface is a graphical user interface.

23. A method in accordance with claim 22 wherein the graphical user interface comprises a slider.

24. A method in accordance with claim 22 wherein the graphical user interface comprises a slider which is actuable using a mouse.

25. A computer readable medium bearing computer program code which, when loaded in a computer, causes the computer to:
semantically filter a set of documents in a database to extract a set of semantic concepts, to improve an efficiency of a predictive relationship to its content, based on at least one of word frequency, overlap and topicality;
define a topic set, the topic set being characterized as the set of semantic concepts which best discriminate the content of the documents containing them, the topic set being defined based on at least one of word frequency, overlap and topicality;
form a matrix with the semantic concepts contained within the topic set defining one dimension of the matrix and the semantic concepts contained within the filtered set of documents comprising another dimension of the matrix;
calculate matrix entries as the conditional probability that a document in the database will contain each semantic concept in the topic set given that it contains each semantic concept in the filtered set of documents;
provide the matrix entries as document vectors to interpret the document contents of the database;
input query terms;
augment the topic set by the query terms;
make an incidence matrix of query terms for the documents;
rotate the document vectors to match the incidence matrix;
cluster and project the rotated document vectors;
display labels for clusters; and
provide a user interface using which a user can adjust the influence of query terms in the labels.

26. A computer readable medium in accordance with claim 25 wherein the user interface is a graphical user interface.

27. A computer readable medium in accordance with claim 25 wherein the graphical user interface comprises a slider.

28. A computer readable medium in accordance with claim 25 wherein the graphical user interface comprises a slider which is actuable using a mouse.
